(19) United States
(12) Patent Application Publication
(10) Pub. No.: US 2009/0313559 A1
(43) Pub. Date: Dec. 17, 2009

(54) OFFICIAL WEBSITE BUILDER/EDITOR COMMUNITY

(76) Inventor: Brendan Kane, Los Angeles, CA (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/483,904

(22) Filed: Jun. 12, 2009

Related U.S. Application Data
(60) Provisional application No. 61/061,147, filed on Jun. 13, 2008.

(51) Int. Cl. G06F 3/01

(52) U.S. Cl. 715/760

(57) ABSTRACT

A user/first party through a web accessible computer creates a first website by electronically accessing a second website operated by a second party, by electronically creating the first website within the second website such that the second website operated by the second party does not constrain the first party to any boundaries, sizes, boxes, templates, and pages in creating the first website, and by electronically saving the first website at the second website.

### RELATED APPLICATIONS

The present application claims the benefit of Provisional Application Ser. No. 61/061,147 filed on Jun. 13, 2008, the entire disclosure of which is incorporated by reference herein.

### TECHNICAL FIELD

The present disclosure relates to website builders and/or editors.

### BACKGROUND

Users such as professional athletes, artists, musicians, etc. frequently create their own websites. However, these websites are scattered, they are difficult to use, they do not easily lend themselves to the generation of revenues for the professional, and they are restrictive in the design and editing of the websites.

### BRIEF DESCRIPTION OF THE DRAWINGS

FIG. 1 illustrates a home page of a web site of a user such as a professional;

FIG. 2 illustrates operation of features for editing the user's site;

FIG. 3 illustrates a video page as an example an editable page of the user's site;

FIG. 4 illustrates a navigation browser that permits a user to edit a navigation tool bar of the user's site;

FIG. 5 illustrates a community that supports the websites described herein;

FIGS. 6-9 and 11 illustrate a flow chart depicting a program executed by the service host computer of FIG. 5; and,

FIG. 10 illustrate a flow chart depicting a program executed by the user computer of FIG. 5.

### DETAILED DESCRIPTION

The model/technology disclosed herein provides top professionals in different industries with high quality official websites allowing the professionals to interact and sell products directly to their fans. Such professionals can include, for example, professional athletes and movie stars.

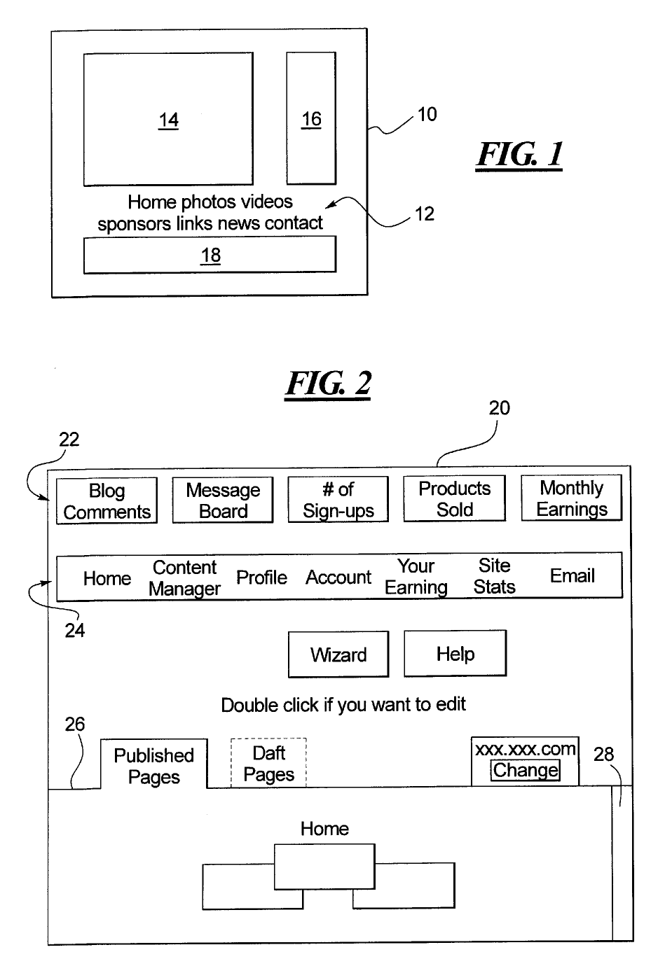

FIG. 1 illustrates a home page 10 of a web site of a professional. The home page 10 includes links 12 to other pages of the professional's website and graphics 14, 16, and 18 that can be used to highlight various attributes of the professional. For example, if the professional is a snow boarder, the graphics 14, 16, and 18 can be used to show the snow boarder in action. However, the graphics 14 can differ in number and can be used for different purposes.

The links 12 can include a link to the home page, photos page, a video page, a sponsors page, a links page, a news page, and a contact page.

This home page link can be part of any or all of the pages of the website.

The photos link is a link to a page which displays various photos that the professionals wishes to display. The photos page can have links to still other pages such as a page offering merchandise, a blog page maintained by the professional, a message board page, a fellow professional page, and a create your own page.

The videos link is a link to a page which allows the visitor to the professional's web site to view various videos offered by the professional such as performances of the professional. The videos page can have the same links as the photos page or different links.

The sponsors link is a link to a page which displays the sponsors of the professional and may have links to the home pages of the sponsors. The sponsors page can also have the same links as the photos page and/or the videos page or the sponsors page can have different links.

The links link is a link to a page which displays links to other websites such as the websites of sponsors and of fellow professionals. The links page can also have any of the links describe above or the links page can have different links.

The news link is a link to a page which displays news about the professional or otherwise. The news page can also have any of the links describe above or the news page can have different links.

The merchandise link discussed above is a link to a page which displays various merchandise that may be of interest to the professional's fans or others. The merchandise can includes merchandise that the professional uses and/or likes and links to suppliers of the merchandise so that visitors to the professional's website can view the merchandise and/or purchase the merchandise from the suppliers. The merchandise page can also have any of the links describe above or the merchandise page can have different links.

The blog link discussed above is a link to a blog page which displays, for examples, various opinions of the professional. The blog page can also have any of the links describe above or the blog page can have different links.

The message board link discussed above is a link to a message board which displays, for examples, various messages from or about fellow professionals, sponsors, or others. The message board page can also have any of the links describe above or the message board page can have different links.

The fellow professional link discussed above is a link to a page which displays, for examples, links to fellow professionals, sponsors, or others. The fellow professional page can also have any of the links describe above or the fellow professional page can have different links.

The create your own link discussed above is a link to a page that allows fans the ability to create a replica of the professional's official site. The create your own page can also have any of the links describe above or the fellow professional page can have different links.

In other words, a fan of a professional snowboarder, for example, can use the create your own page to access (for a monthly fee) a design of the professional's website and to populate it with the fan's own pictures, videos, information, etc., resulting in the fan's own official website that presents the fan's skills in a high quality manner to friends and other like minded fans.

Professionals participating in the program earn 50% (or another percentage) of the revenue generated from every sign up they refer. At the same time, this model/technology enables fans to promote the “create your own official website” product to their friends and earn 50% (or another percentage) for every person they refer, thus forming a network that is owned by the community.

In other words, this is one big affiliate community where everyone shares in the revenue that they generate for the community.

This community can function and be used for many different industries. For example there can be a version for the extreme sports industry, film industry, music industry, all major sports (e.g. basketball players, baseball players, soccer players, hockey players), photography industry, the fashion industry, comedy industry (e.g. comedians), art industry, model industry, real estate industry, pet industry, etc.

The incentives offered to the professionals can include the following: the professionals earn 50% (or some other percentage) of the revenue generated by signing up any fan/amateur to the program such as for the first 3 years (the price for fans/amateurs to sign up and create their own official website is, for example, $10 per fan/amateur, and the price for any fan/amateur to sign up for a standard profile page is, for example, $3); and, professionals receive an official website at no charge (hosting included) with (i) the ability to upload, host and display videos and photos, (ii) individual pages to feature sponsors and links (e.g. link to their MySpace profile, sponsors websites), (iii) a customizable blog, (iv) a customizable news page that allows the professional to post stories pertaining to his/her career and/or sponsors, (v) a message board, which allows fans to communicate with each other as well as with the professional, (vi) a fellow professionals page, which lists fan, amateurs, and/or other professionals with whom the professional is connected (this functions in a similar manner to having friends within a social network, (vii) and/or a contact page that contains all of the professional's contact information.

There are additional features of the service disclosed herein. If a Pro does not have a domain (e.g., professional's name.com), the service obtains an available domain for the professional. The service will register the domain name for a fee such as $10 per year. The service running the community, for example, may subtract this fee from any revenues earned by the professional. If the professional already has a domain, the service running the community can implement the domain into its site at no additional charge.

The service that hosts this ecommerce system can provide professionals with the ability to sell their own products and/or their sponsors' products directly through their official sites. As a service fee, professionals either pay a small fee per product that is posted or they can post products for free with the hosting service running the community collecting a small percentage of the revenue from each sale. For professionals who do not have their own merchandise (e.g. clothing line, custom equipment), the hosting service allows professionals to post custom designs for sale and each time a fan places an order the hosting service running the community produces the product and ships it directly to the fan. Professionals and the hosting service running the community split the profit from each sale at some ratio such as 50/50.

Within the community, the hosting service can host different types of pages such as (i) a professional page, (ii) an amateur page, (ii) a fan page that works the same way as an amateur page, except that the fan page can have a different layout such as a profile to look to it and reduced functionality, and the fan page can have a cheaper monthly fee than the standard amateur page with the functionality needed to charge a different price for this page, (iii) a company page for an official website where the company sells its products and offers information, (iv) a team page where professionals and/or amateurs set up a page that contains a group of different professionals (this page functions in the same manner as an amateur page with all of the same features and functionality; there is a monthly charge to set up this page; and, the only new aspect is a page that lists all of the individual professionals and may contain links to those professionals' official sites if they exist, and (v) pages geared toward female athletes (these pages are no different than professional and amateur pages, they just have a design targeted to females geared design.

There are many features that the individual sites and the community as a whole can have.

The sites offer a language translator such that when a visitor visits a professional's website from a foreign IP address, a box pops up asking in what language the visitors want to view the site. Users can create a page in a foreign language. For example, a user in Russia should can create a page using Russian text.

Each website has a fellow members page which functions in a similar manner as a friends section in a social network. Each fellow member is represented, for example, by a square image. This square image can be taken from one of the images used on the home page of the user, or the user can select an image specifically for this icon. When a person clicks on the icon located on the fellow member page, it directs that person to that user's page.

If a user does not fill out a specific page (e.g., the news page), that page it does not show up on the tool bar or anywhere else on the front end. In other words, users can disable any aspect of the site they want.

The advertising technology of MyPaidAds, LLC can be integrated into this platform to allow each individual user with a website or profile the ability to select an advertisement from a pool of advertisers hosted by the main company and place the advertisement on his/her website, and each time a visitor engages with the advertisement, the website creator earns a portion of the advertising revenue generated by the advertisement.

Also, with this advertising technology, each individual user with a website or profile has the ability to program his/her own internet channel with his/her own content and content from within the community. In programming the channel, he/she selects the content as well as the advertisements that appear on or within the channel. The user earns a percentage of any revenue generated by the advertisements placed within the channel.

Each website has the ability to contain flash elements.

Each user has the ability to create a virally distributable slideshow out of the photos they have uploaded to the site.

Users are able to watermark any video that they upload to their pages with their URL (e.g. matthammer.com). This video is also hosted in a virally distributable player that can be posted to their facebook, myspace, etc., pages.

On the merchandise page, under each product that the amateur or pro is selling, there is a link to more information. This link leads to a standard page with information about the product, and may link out to an affiliates website as well. Professionals also have the ability to create a custom information page. On this page, a professional can write a description or upload a video talking about a product and/or about the professional using the product.

Email notifications can be sent similar to facebook when someone: comments, purchases something, signs up through a site, requests to become a fellow professional, etc.

Users can place their sponsors logos on the front page.

Users can place ads on any page so that they can share in the advertising revenues.

The affiliate program (e.g., where people earn 50% (or another percentage) of the revenue generated from the users they get to sign up) is also open to blogs, general websites, or people, companies, firms that specialize in marketing.

The time length in which an affiliate earns 50% (or another percentage) of the revenue generated by a user they get to sign up is flexible and can be changed by the administrator. For example, the administrator can program the system to only pay the 50% (or another percentage) for the first 3 years. The administrator also has the ability to just payout a flat fee instead of 50% (or another percentage) of the revenue, for example $40 per acquisition.

There is an archive system in place such that, if users choose another design or another professional's website that they wish to duplicate, the users can launch the new design but still save their old websites for future use. In other words, once designs are stored in the archival system, the users can choose to activate that design at any time. When users activate designs in the archival system, the designs will replace the current live sites with the sites that were chosen in the archival system. The users will also be able to archive single pages for future use. In other words, if users wish to design new home pages (or any other types of pages), or several home pages, for future use, they can create the new designs and save them in the archival system without them showing up on the live sites. When the users want to replace the current home pages with the ones saved in the archival system, they can easily activate the pages, and the current home pages will be replaced with the ones chosen in the archival system.

Users can also utilize a storage system for their assets. The storage system allows users to store current assets and past assets (e.g., old photos, old videos, etc.) that are not currently being used on the sites but that the users may want to access at a future date.

Users have the ability to design their own equipment such as snowboards, surfboards, and skateboards and sell it through their websites. When someone orders one of these custom products, the service host either produces the product itself or hires another company to produce and ship the product. The service host company has the ability to collect all of these orders in a file and send the file directly to the factory for creating the product.

Users also have the ability to design their own clothing (e.g., t-shirts, sweatshirts, and hats).

There are features that can be shared by professionals, amateurs, fans, and service host/product pages. Each website has a clickable watermark with the community name, so that when visitors visit an official site. they know that the site is a part of the larger community.

Both professionals and amateurs have an administrator section that tells them how much they are earning. This section displays how much they have earned from referrals, how much they have earned from their referral's referrals, how much they have made from affiliate sales/and or advertising. etc.

Professionals and amateurs have the ability to post sponsor or advertiser backgrounds on one of their website pages (e.g., home page, photo page, or other page) or on every single page and earn money or points based on traffic. In other words, a user could decide to put a coke background on his website and earn money based upon the amount of traffic his website generates while the coke background is present.

Users have the ability to set up a custom email address or submit a pre-existing email into their contact page.

The service host also has an offer that if users want the service host to update their sites for them, they can pay an additional monthly fee.

All of the information on the users' pages can be searched by all search engines.

When users switch designs, all of their data from their old designs can be used for their new designs and/or are transferred automatically.

There are a number of features for the administrator section.

The administrator area of the community has a section were the administrator can add new outgoing affiliates (meaning the service host running the community is pushing traffic to another source) and earning an affiliate fee. For example, the service host running the community signs up for an affiliate program such as a programs of a snowboard company. The administrator adds the products for this snowboard company (through the backend end) into a specific section, or the snowboard company can add the products themselves. On the front end of the site, these products show up in a section called Merchandise. Anyone (both professionals and amateurs) is able to select certain merchandise and place the selected merchandise on a corresponding page in a “what I like” (or other name) section. These products can also appear on other pages of a website. On each users website, there can be a “what I like page” and within that page there can be different categories for the products the user has chosen. For example, for an athlete, one category could be called “What I ride” or “What I use” which displays products that the user actually uses when participating in the sport. Another category example, is “products I recommend” which displays products that users may not actually use but that they still enjoy. When users find ads that they like, they can click on the ads which pops up windows that say “are these products that you ride or recommend?” and then the users can choose one. Once they choose, the product is automatically added to their “what I like” page or any other page of their choice. When someone visits a user's site and engages the ad or purchases something, the service host earns an affiliate fee and then the service host distributes 50% (or another percentage) of the revenue to the user. If the amateur user is on a points based system (meaning they earn points redeemable for prizes instead of money), they earn points based on the acquisition and the company takes 100% of the revenue. Every time users (e.g., professionals) select ads and place the ads on their “what I like page” or any page on their website, unique IDs are assigned to these ads in order to distinguish which users need to be paid after a purchase has occurred.

The time length in which affiliates earn 50% (or another percentage) of the revenue generated by users they get to sign up is flexible and can be changed in the administrator. For example, the administrator can program the system to only pay the 50% (or other percentage) for the first 3 years. The administrator also has the ability to just pay a flat fee instead of 50% (or other percentage) of the revenue, for example $40 per acquisition.

The community also has an advertising based model built in. The administrator can choose to run the advertising instead of or in addition to the subscription model. In the advertising based model, users earn a portion of the revenue generated from their pages (in addition to the subscription fee, the administrator can choose to allow the users to earn a percentage of either revenue stream or earn a percentage of both). In other words, based on the amount of traffic they generate, the users earn advertising revenue. For example, if the average CPM (cost per thousand impressions) is $10 they earn 50% (or another percentage) of that. For anyone they get to sign up they earn a percentage of the advertising revenue generated from their page. If the advertising model is implemented the affiliate fee earned from the sales of products still work as is.

There are features for professional accounts (any of these features can also be implemented by the administrator on any other type of account).

In the beginning, all professionals, for example, get their sites completely free. But the service host has the option in the administrator to take costs of domain registration and hosting out of incoming revenues of the professionals. If the professionals they do not make enough to cover these expenses, the service host can choose to pay for the expenses. Every professional account is set up through the administrator to take expenses out of the professionals' revenues, but the administrator has the option to change this for each individual professional account and not take out any money for expenses.

Here is an example of when the service host does take out expenses from their revenues. There is an expense of $10 per year for a domain, which is about $1 per month, and a hosting expense of $5 per month, which means there is about $6 per month expenses. If the revenue share split with the professional was 50/50 at $10 per fan account, the professional would only need to refer (get them to sign up) two people in order to start earning money. Once the professional has two people to sign up, the professional earns $4 per month ($10 in revenue less $6 in expenses).

Visitors/fans also have the ability to have video introductions on the front pages to introduce their sites and to promote the fact that they can create their own sites. Or, when they click on the “create your own site,” they are taken to a sign up page with a video from that professional convincing the visitors/fans to sign up.

The administrator has the capability to fluctuate the percentage of revenue split to each professional. In other words, the administrator has the ability to pay a professional more or less than 50% (or other percentage). As mentioned above, the administrator also has the capability to fluctuate the length of the payout to a professional. For example, the administrator can start out paying professionals indefinitely, but as the sites gets popular, the administrator can elect to change the time length (e.g. 3 years).

On the community home page, the administrator has the ability to feature any individual persons, and then send notification emails to the members notifying them when they appear on the homepage.

Professionals have the ability to also earn points that can be redeemable at some point for some type of prize. These points can be based on how many people they get to sign up (this is worth a set amount of points), how many products they sell (this is worth a set amount of points), and how much traffic (they earn a set amount of points based on the number of CPM's they generate). An administrator section charts all of the points and lists them in order of most amount of points to least amount of points. This points list is separate from amateurs.

There are features for amateurs/fan pages. However, any of these features can also be implemented by the administrator on any other type of account. For example, certain websites of professionals may be too advanced for an amateur to be able to create on their own. For example, pro name.com may have a cut out image of him on the right hand side of the page. For this level of design, the service host can charge an additional fee to customize an image for the user. This feature is an additional line item (listed creative support) on the sign up page. This is noted by the administrator in the administrator section. The service host also allows users the option to create designs on their own if they know how to use Photo shop and Flash. The service host also provides simple instructions on how to implement the image or cut out the background in Adobe.

Amateurs/fans also have the ability to pay extra for the service host to build them a custom design/site.

Since amateurs and fans are paying for their sites, they are able to take off the referral/affiliate link.

There is a section in the community that lists the top amateur account. This list is based upon points. The administrator has the ability to override the points and choose the top amateurs. The administrator has the capability to have a watermark label on the amateurs' sites showing what their ranking is (e.g., “This user is ranked 25^{th}”).

Amateurs are charged a domain fee (if they wish the company to secure them a custom domain) in addition to the monthly usage fee. If the amateur gets two people signed up, the service host has the ability to no longer bill them, and then for every person that they sign up past the two person mark the user starts earning money. The administrator must have the users billing information at all times, in case the users dip below the two person mark (meaning that the people they got to sign up cancel), in that case the user starts to be billed again. If the amateurs are on a points based model (meaning they are under 18 and are not earning cash), once they hit the two person sign up amount, they are no longer charged, and the same rules apply as above if they dip back below under the two person mark. Once they are over the two person mark, they start earning points toward prizes. Points earned from getting people to sign up is the only way for them not to have to pay for the service, points generated from any other activity (traffic, selling products, etc.) do not count towards not having to pay.

As mentioned above, if amateurs are under 18 (and they do not have their parents sign up for them), they sign up for a points program. This points program allows them to earn points that they use to redeem for prizes and/or to earn professional status. The different aspects for which they earn amateurs points are as follows: number of visitors, number of people they get to sign up, number of video views, and/or the number of products they sell through their own sites. In the administrator area, there is a section where the administrator can view the points earned by each individual and the total points earned by the community as a whole.

The administrator has the capability to fluctuate the percentage paid out to amateurs based on their referrals. For example, the service host might want to say that all amateurs who signed up during the first six months can keep earning 50% (or another percentage) but all new users only earn 45% (or another percentage). As mentioned above, the administrator has the capability to fluctuate the length of the payout. For example, the service host can start out paying amateurs indefinitely but as the site gets popular they may change it to a limited time frame (e.g., 3 years).

The administrator has the ability to provide a simple profile page for free with advertising running on the profile.

The administrator also has the ability to increase the price on certain designs/pro designs as the quality of the site increases or if the demand for a specific professional design increases.

Amateurs can submit their websites and/or content to the service host for consideration to be given a professional account. The user must be a paying member in order to be evaluated. This evaluation can speed up the process of an amateur becoming a professional.

For the points system, the administrator has the ability to edit the amount of each individual's points.

Amateurs earn points based on how many people they get to sign up (this is worth a set amount of points), how many products they sell (this is worth a set amount of points), and how much traffic (they earn a set amount of points based on the number of CPM's they generate). An administrator section charts all of the professional's points and lists them in order of most points to least points. This points list is separate from amateurs.

Companies have the ability to create their own pages within the community. These pages are different than normal user sites and are at a different price point. Companies have the ability to have more pages, add more content, and they have different layouts from which to choose. Companies can also create sites just for specific products. For example, if Burton snowboards releases a new snowboard, it can create a website solely for that snowboard. On that site, Burton could provide all of the information for that board and even sell the board through the site.

The administrator has certain features available on the Community home page, including a top video section on the front page. This pulls from the videos on each individuals page. The ranking of these videos is based on the number of views, and the administrator can choose which video is highlighted. The player on the front page pulls the video feed directly from the individuals page. There is also a link leading directly to the person's page that posted the video.

The administrator has the ability to add a contest to the community front page. For example, a best trick contest, where users upload videos each having a single trick, and people vote on the best trick. The user with the most votes wins.

There can be other features. For example, in the administrator section, there can be a tool to track incoming traffic on each of the individual sites, in addition to the traffic of the community as a whole.

There is also statistic tracking on the home page as well as any additional community pages.

As mentioned above there are different pages within the community. For example, in the extreme sports community, there are pages for musicians, which are labeled differently than professionals and amateurs. The musician sites are labeled musicians (there is no professional or amateur level). When musicians befriend athletes, they show up in their fellow members section as musicians.

The administrator has the ability to run pre-rolls and post-rolls on videos uploaded by users, even when the video is playing on the individual users site. The admin also has the ability to select specific user pages that the ads will or will not play on.

On both the “about us” page and the billing page, there is a video player that explains the program to parents that are signing up their children, so that if children have to get their parents to pay the subscription fee, they can show it to them. The video tells parents on their level and sells them on the concept. Parents have the option to have their children either earn points redeemable for prizes (which is good for the parents, because that means they have to buy their children less stuff), or they can have their children earn money (means no more paying allowances and teaching them about business at the same time).

On the community home page, the administrator has the ability to post a gallery with all of the professional designs from which users can choose.

Certain professionals have signature series designs named after the professionals (e.g., The Pro Name design).

There is difference between the professional and amateur accounts on the front end and backend. Everyone is marked as an amateur who signs up and pays for the service. Professional accounts have to be approved by the administrator. The administrator has the capability to change a user from an amateur status to a professional status at anytime.

On the front end, professionals and amateurs are separated in a few separate places. First, on the community home page, there is a featured professional section and there is a separate section for featured amateurs. Also, in the friends section, when someone is added to a person's page as a friend, the friend is either added as a professional friend or an amateur friend. A different water mark logos are provided for the amateurs and for the professionals.

For customer service, users can send instant messages to a technical support team and ask questions or get help for creating their websites. The screen name for this feature would be listed in the tech support section.

The service host offers edit tools for the community. Unique features of this model/community are the innovative tools provided to users for the creation and editing of their official sites. All of the creation and adding of content happens within the page itself. For example, when first creating their sites, users choose the designs that they wish to use for their own websites. The designs, for example, may be simply web pages that have already been created for a professional or amateur, and the designs may or may not be a current version that a professional or amateur is currently using. Once a user has chosen a design, the next step is for the user to add content. So the user in the administrator section chooses a first page to which content is to be added. If for example a photos page is chosen as the first page, the user selects the photos page by clicking on it. Then, an exact version of how the page looks to visitors opens up, except the page that opens up can be completely controlled and edited by the user. Once the user has the photos page up, the user can choose a photo that is either located on the user's desktop or that has already been uploaded to the community system and add it anywhere on the screen. The user then drags the photo to where ever the user wishes to place it. In other words, while the page is open, the user can add any content just by selecting it or dragging the content into the page using a mouse. Now once the user has content where the user wants it, the user can customize that piece of content in any desired manner. For example, once the user has added a photo to the photos page, the user can crop the size of the photo, move the photo to any part of the page, change the background color of the photo, add effects to the photo, move the photo behind a tool bar or behind a video player, etc. These same features apply for any type of content that a user wishes to ads to a page (e.g. videos, text, tool bars, logos, animations, flash, etc.).

The user can also customize any aspect of a chosen design. For example, if the user chooses a design where the tool bar is on the top of every page, the user can move the tool bar to the bottom of every page, or they can choose to have the tool bar on the bottom of every other page. The user can change the background colors of pages, change the color of tool bars, choose to only upload one photo even if there are slots for four photos (the other slots would disappear), and add five photos if there are only slots for two photos. In other words, the user has complete control to edit, rearrange, or add to the chosen design, and all of this happens within the page itself. A user could in fact take a professional's design and change the whole site around so that it looks nothing like the original design.

A unique aspect of this technology is that it is not a template or modular based system. Users are not restricted by any boundaries, sizes, or boxes in constructing any individual page or the entire site as a whole. In other words, users could start with a blank page and design whatever comes to their mind (e.g. colors, number of photos, types of photos, if there is a video player or not, what type of navigation, how many pages the site will have, etc.) and the system will comply with those instructions and make the users design/instructions work.

FIG. 2 illustrates how the editing features actually work. In addition to making the edits within a page, more technically advanced users have the ability to access the application programming interface (API) that each website functions off of and to change the way their website functions completely. The API is a set of routines, data structures, object classes, and/or protocols provided by libraries and/or operating system services in order to support the building of applications.

Users are able to choose from multiple tool bars (a tool bar consists of links to the different users website, e.g. home, bio, videos, etc.) so they are not stuck with a particular style tool bar. For example, if they are using a tool bar that is horizontal (meaning the titles home, bio, etc.) go from left to right, they can choose one that lists from top to bottom. They can also choose ones with different colors, style, fonts, etc.

In addition to moving any aspect of the page around by dragging it with a mouse, users will be able to move objects around with their fingers by utilizing a touch screen. In other words, the system will be able to be used on touch screen devices, so users can simply edit their site by touching their page and moving objects around or modifying other aspects, such as colors, background images, etc. This includes mobile devices. Users will be able to edit and move around their site from their cell phone or other electronic mobile device.

The user logs into the user's administrator section and browses through different pages of the user's website. FIG. 2 illustrates an administrator section 20 of the service host's website. The administrator section 20 has various buttons 22 to give access to the blog page, the message board page, the number of sign ups, the products sold, and the monthly earnings of the user. The administrator section 20 has various links to the home page, to a content manager, to a profile of the user, to the user's account, to the user's earnings, to statistics regarding the user's site, and to an email function that can be used to send and receive email.

Each page within the user's official site (e.g., home page, video page, photos page) is represented by a large screen shot that show exactly how each page appears at the current time, which is conveniently placed in a scroller so that the user can scroll through the different pages, such as by use of a scroll bar 28, that allows the user to choose which page the user chooses to edit.

The user scrolls to the page that the user wants to edit and then clicks on that page. For example, the user may click on the videos page. A full editable version of this page then opens. FIG. 3 illustrates full editable video page 30 as an example. The page 30 has buttons 32 for loading a new page, managing pages, managing content, managing designs, invoking a page editor, etc. The page 30 has pull down menus 34 allowing the user to add elements to the page, edit the page, upload video to the page, etc. The page 30 has a video 36 that can be played, the page 30 has graphic elements 38, and the editable video page 30 has a navigation tool bar 40. The navigation tool bar 40 can include links to other pages such as the merchandise page, the blog page, the message board page, the fellow professional page, the sponsors page, and the create your own page.

The user can then change any aspect of this page. For example, the user can move the name “USERS NAME” to the bottom of the page and can change the font using the text editor. The text editor is opened by selecting it from a menu within the editor, or by selecting a piece of text and choosing to edit it.

From the text editor, the user can select text such as by highlighting and can select a new font for the selected text. The name can be moved simply by dragging the name to a new location on the page 30.

The user can also select a new tool bar for the page 30 by invoking a navigation browser 50. Selection of the navigation browser 50 causes the navigation browser 50 to pop up on the screen.

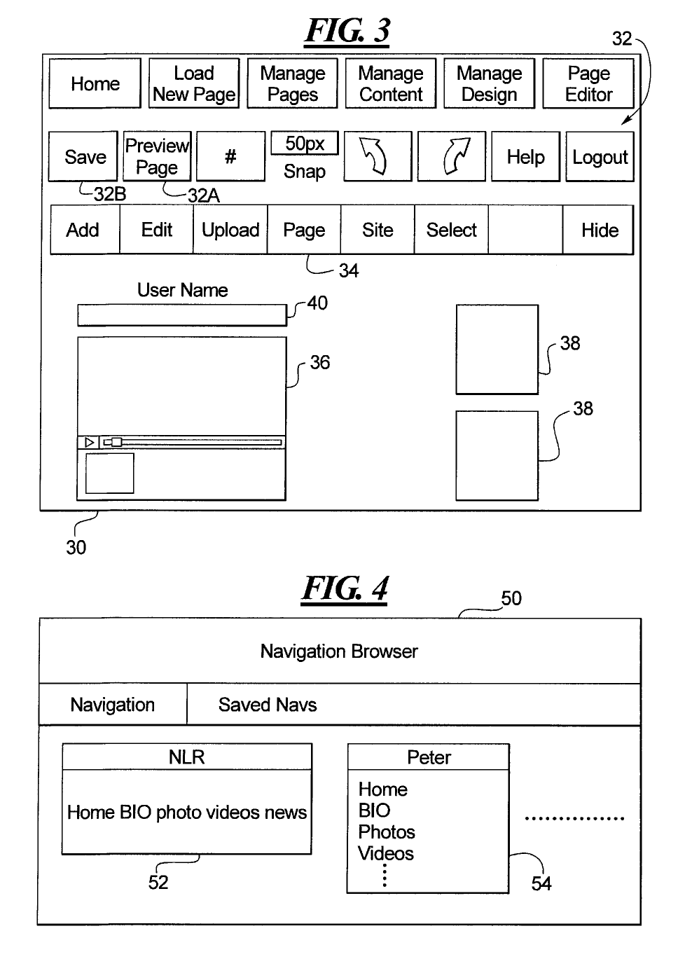

The navigation browser 50 is shown in FIG. 4 and permits the user to choose a new navigation tool bar and delete the old navigation tool bar 40. The navigation browser 50 displays a plurality of different navigation tool bars, such as navigation tool bars 52 and 54 each containing different links and/or links arranged in different patterns. The navigation browser 50 may display more or fewer navigation tool bars than those shown, the navigation browser 50 may be contained in a scrollable window that permits scrolling through the displayed navigation tool bars, the navigation browser 50 may include pull down menus that permit the use to add and delete navigation tools bars displayed by the navigation browser 50, etc.

The user selects a desired navigation tool bar from the navigation browser 50 such as by double clicking on the desire navigation tool bar causing the desired navigation tool bar to pop up in the editable video page 30. The desire navigation tool bar may then be dragged to a desired location in the editable video page 30. Alternatively, the user may simply drag a desired navigation tool bar from the navigation browser 50 and to a desired location in the editable video page 30.

The other elements, such as the video, may dragging to different locations on the editable video page 30. Also, the color of the editable video page 30 can be changed.

When the user is finished making changes to the editable video page 30, the user can preview the editable video page 30 by selecting the preview page button 32A (FIG. 3) of the buttons 32. The preview shows the page as it will be seen by people visiting the website. Once the user is satisfied with the site, the user clicks on the save button 32B (FIG. 3) and all changes are updated to the site instantly.

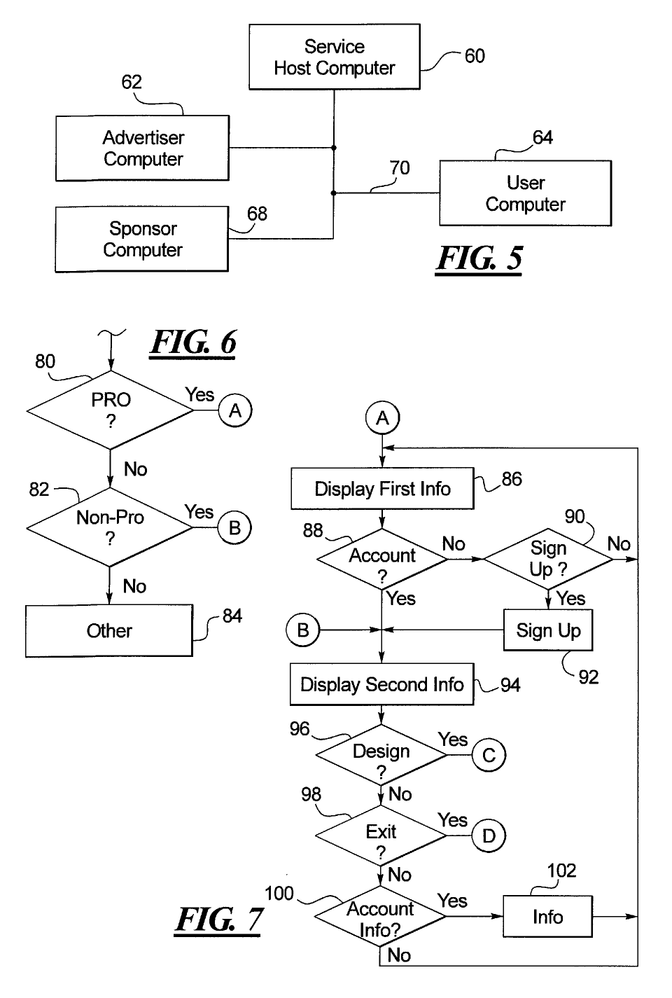

An example of a community that supports the websites of users such as professionals is illustrated in FIG. 5. As shown in FIG. 5, a service host computer 60, an advertiser computer 62, an individual user (e.g., professional) computer 64, and a sponsor computer 68 are interconnected by a communications medium 70 such as the Internet. The advertiser computer 62 and the sponsor computer 68 can be separate from or part of the service host computer 60. Each of the computers 60, 62, 64, and 68 will be understood to include one or more computers having access to the communications medium 70.

The service host computer 60 hosts the personal website of a user such as a professional. As described above, the personal website of the user may include one or more pages such as the merchandise page, the blog page, the message board page, the fellow professional page, the sponsors page, and the create your own page. As also described above, the service host computer 60 permits the user to design and/or edit the user' personal website, permits visitors to visit the user's personal website, and may permit the user's personal website to display advertisements from advertisers and/or sponsors.

Thus, the user through the user computer 64 accesses the service host computer in order to design and/or edit the user' personal website, which is then hosted by the service host computer 60. The user by use of the user computer 64 can select advertisements from the advertiser computer 62 and/or the sponsor computer 68 for association with the user's personal website hosted by the service host computer 60. Alternatively or additionally, the user by use of the user computer 64 can add links that link the advertiser computer 62 and/or the sponsor computer 68 to the user's personal website hosted by the service host computer 60.

A user can be a professional, a fan, an amateur, or other person. Therefore, users other than professionals have the same tools as the professionals in creating, designing, and editing their own websites hosted by the service host computer 60.

FIGS. 6, 7, 8, 9, 10, 11, are flow charts of operations that are implemented by the service host computer 60. As shown by the flow chart of FIG. 6, the service host computer 60 determines at 80 whether the professional user has accessed the service host computer 60 over the communications medium 70. If so, flow proceeds through point A to FIG. 7. If not, the service host computer 60 determines at 82 whether a non-professional user has accessed the service host computer 60 over the communications medium 70. If so, flow proceeds though point B to FIG. 7. If not, the service host computer 60 determines at 84 that someone else has accessed the service host computer 60 over the communications medium 70, in which case the service host computer 60 appropriately performs other processing.

Assuming that the professional user has accessed the service host computer 60 as determined at 80 of FIG. 6, the service host computer 60 at 86 of FIG. 7 displays appropriate information to the professional user. For example, the professional user may be presented with information about receiving payment for associating advertisements with the user's official website, for selling product through the user's official website, etc. The professional user may be allowed to browse available advertisements.

After 88, the service host computer 60 determines at 88 whether the professional user has previously established an account with the service host computer 60. For example, the service host computer 60 may determine that the professional user has an account if the professional user is simply able to log on to the service host computer 60 at this point.

If the service host computer 60 determines at 88 that the professional user does not have an account with the service host computer 60, the service host computer 60 at 90 offers an opportunity for the professional user to sign up for an account. If, as determined at 90, the professional user chooses not to sign up for an account with the service host computer 60, an exit screen can be presented to the professional user as desired and flow returns to 86.

If, as determined at 90, the professional user chooses to sign up for an account with the service host computer 60, the service host computer 60 processes the sign up operations at 92. If the professional user previously signed up for an account as determined as 88, or after the professional user signs up for an account with the service host computer 60 at 92, or if a non-professional user is passed to the program of FIG. 7 through point B, additional information is displayed to the user at 94. This additional information, for example, may include information about the design and editing of websites. The user is also prompted to select designing and/or editing an official website and/or viewing account information.

Alternatively, no distinction need be made between professional and non-professional users such that all users enter the program of FIG. 7 through point A.

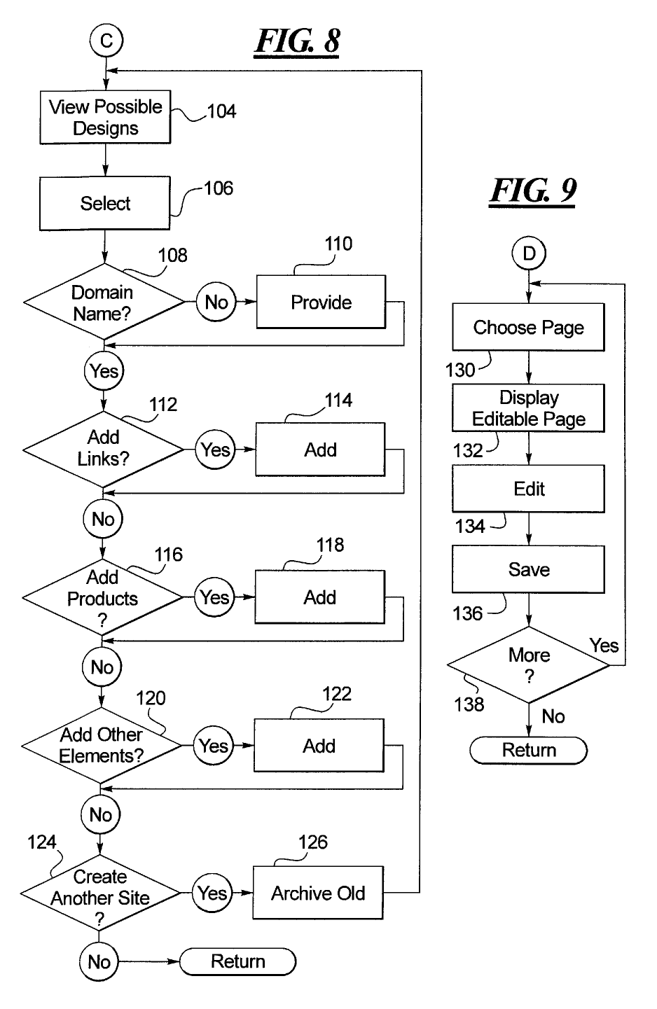

Accordingly, as shown by the flow chart of FIG. 7, the service host computer 60 determines at 96 whether the user wants to design an official website. If so, flow proceeds to FIG. 8. If not, the service host computer 60 determines at 98 whether the user wants to edit the user's existing official website. If so, flow proceeds to FIG. 9. If not, the service host computer 60 determines at 100 whether the user wants access to account information. If so, access to the user's account information is provided at 102. If not, flow returns to 86.

As shown in FIG. 8, if the user chooses to design an official website, the service host computer 60 at 104 offers the user possible designs or a blank page of a website to be created. At 106, the user selects a design and begins the process of customizing that design.

At 108, the service host computer 60 asks the user if the user already has a domain name for the user's official website. If not, the service host computer 60 at 110 provides a domain name for the user. If the user already has a domain name for the user's official website, the user is instructed to enter the user's existing domain name to the service host computer 60.

After the service host computer 60 at 110 provides a domain name for the user, or after the user enters the user's existing domain name, the service host computer 60 at 112 asks the user if the user wishes to add links to the user's official website. If the user wishes to add links to the user's official website, the user adds those links at 114. These links may be links to sponsors, to fellow professionals, to advertisers, etc.

After the user adds links at 114, or if the user indicates that the user does not wish to add links to the user's official website, the service host computer 60 at 116 asks the user if the user wishes to add products to the user's official website. If the user wishes to add products to the user's official website, the user adds those products at 118. These products may be products that the user has designed or products offered by sponsors, or products offered by advertisers, etc.

After the user adds products at 118, or if the user indicates that the user does not wish to add products to the user's official website, the service host computer 60 at 120 asks the user if the user wishes to add other elements to the user's official website. If the user wishes to add other elements to the user's official website, the user adds those other elements at 122. These other elements may be videos, graphics, etc.

After the user adds other elements at 122, or if the user indicates that the user does not wish to add other elements to the user's official website, the service host computer 60 at 124 asks the user if the user wishes to design another official website. If the user wishes to design another official website, the existing official website is archived at 126 and program flow proceeds to the 104 where the user can begin the process of design another official website. If the user does not wish to design another official website, program flow returns.

As shown in FIG. 9, if the user wishes to edit the user's official website, the user at 130 chooses a page of the official website to edit. The host service computer 60 then at 132 displays an editable version of the page to be edited. For example, if the user clicks or double clicks on the chosen page, the chosen page is displayed as an editable page.

At 134, the host service computer 60 prompts and accepts edits by the user and, at 136, saves the edited page. At 138, the service host computer 60 determines whether the user has more pages to edit. If so, flow returns to 130. If not, program flow returns. An of the edits described above using any tools including the ones described above may be used by the user in editing the user's official website.

The service host computer 60 at 86 and/or at 94 can display an about us page and/or a billing page that includes, for example, a video player to play a video that explains the program to parents who are signing up their children, so that if children have to get their parents to pay the subscription fee, they can show it to them. The video tells parents on their level and sells them on the concept. Parents have the option to have their children either earn points redeemable for prizes (which is good for the parents, because that means they have to buy their children less stuff), or they can have their children earn money (means no more paying allowances and teaching them about business at the same time).

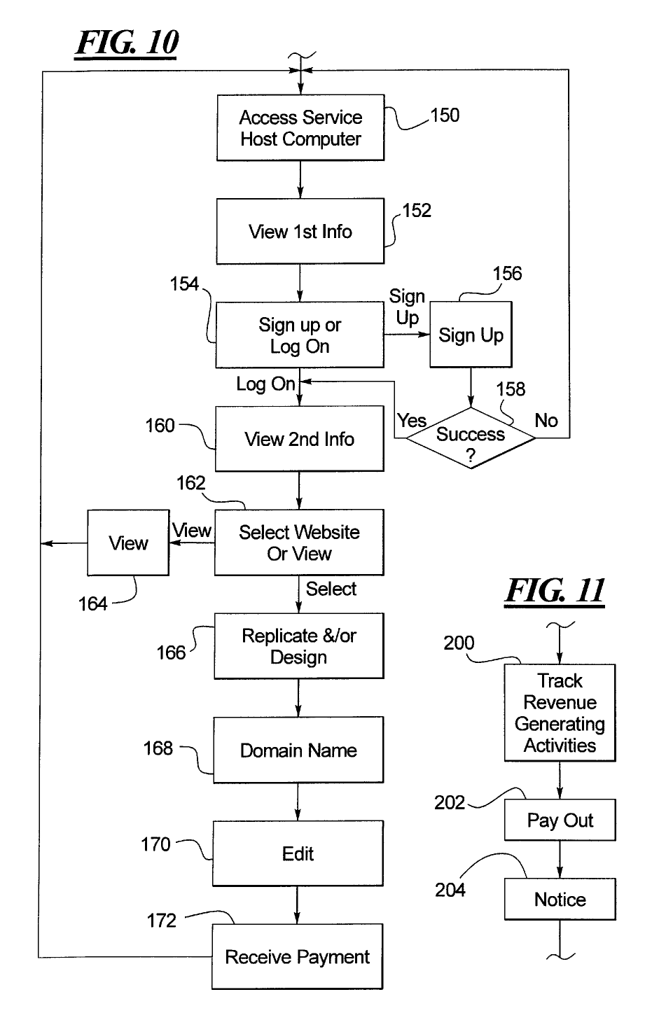

FIG. 10 is a flow chart of the operations that are implemented by the user through use of the user's computer 64. As shown by the flow chart of FIG. 10, the user at 150 accesses the service host computer 60 and at 152 views information provided by the service host computer 60. This information is the information displayed by the service host computer 60 at 86.

If the user has not previously established an account with the service host computer 60, the user may choose at 154 to sign up for an account with the service host computer 60. On the other hand, if this access to the service host computer 60 is not the first access by the user of the service host computer 60, the user may instead simply choose at 154 to log on to the service host computer 60. Alternatively, the user may choose neither option at 154, in which case flow returns to 150.

If the user 14 chooses at 154 to sign up for an account with the service host computer 60, the sign up process is performed at 156. If the sign up process is not successful as determined at 158, flow returns to 150. If the sign up process is successful as determined at 158, or if the user chooses at 154 to log on to the service host computer 60, the user is provided additional information at 160. This additional information is the information displayed by the service host computer 60 at 94.

The user at 162 is able to select or view a website. If the user wishes to merely view the website, the user performs the view at 164, after which flow returns to 150. If the user instead selects a website at 162, the user at 166 may use the selected website for replication during creation of the user's website. Alternatively, the user at 166 can instead design a website not by replicating an existing website but rather by starting with clean pages of the website to be created. Alternatively, the user may elect at 162 to both view and select a website.

The user at 168 either provides the user's domain name or, if the user does not have an existing domain name, requests the service host computer 60 to obtain one for the user. At 170, the user may edit the existing website or a website being created using any of the tools and/or procedures described above.

The user at 172 may electronically or otherwise receive payment that is due.

Flow returns to 150.

As shown in FIG. 11, the service host computer 60 at 200 tracks revenue generating activities with respect to the user, at 202 pays out revenues at the appropriate times to the user, and at 204 sends out any relevant notices to users at the appropriate times.

Modifications of the present invention will occur to those practicing in the art of the present invention. For example, the order of operations shown by the flow charts described herein need not be in the order shown and need not all be executed during a single session on the service host computer 60.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

The appendix I explains more about the subject matter discussed above.

I claim:

1. A method performed by a web accessible computer of a first party to create a first website comprising:
electronically accessing a second website operated by a second party;
electronically creating the first website within the second website, wherein the second website operated by the second party does not constrain the first party to any boundaries, sizes, boxes, templates, and pages in creating the first website; and,
electronically saving the first website at the second website.
